(19) United States
(12) Patent Application Publication
(10) Pub. No.: US 2005/0140819 A1
(43) Pub. Date: Jun. 30, 2005

(54) Imaging system

(75) Inventors: Hiroyuki Kawamura, Tokyo (JP); Tomoyuki Ohata, Tokyo (JP); Hironori Hoshino, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Niles Co., Ltd., Tokyo (JP)

(21) Appl. No.: 11/011,128

(22) Filed: Dec. 15, 2004

(30) Foreign Application Priority Data
Dec. 25, 2003 (JP) 2003-431144

(51) Int. Cl. H04N 5/235

(52) U.S. Cl. 348/362

(57) ABSTRACT

An imaging system according to the present invention is capable of outputting an image which is less unnatural while elongating a signal storage time of a CCD camera gradually. It includes an IR lamp for radiating an infrared ray, a CCD camera 5 for taking the place radiated by the IR lamp and converting it into an electric signal, and an image processing unit 7 capable of outputting an image with a different exposure value continuously and periodically, while varying a signal storage time of the CCD camera 5 at a predetermined period. The image processing unit 7 is characterized by outputting an image that is different in exposure depending upon a signal storage time according to the extent to which how strongly light strikes on the CCD camera 5, and elongating gradually the signal storage time when there is no strong light falling on CCD camera 5.

### BACKGROUND OF THE INVENTION

1. Field of the Invention

The present invention relates to an imaging system using a CCD camera.

2. Description of the Related Art

The conventional imaging system includes, for example, that one as shown in FIG. 24. In FIG. 24, this system includes a CCD camera 101 as imaging means, a digital signal processor (DSP) 103 as an image processing unit, and a CPU 105.

The CPU 105 is connected to the DSP 103 through a multiplexer 107, and receives a signal from a shutter-speed setting switch 109. The shutter-speed setting switch 109 is adapted to set the shutter speed for an odd number (ODD) field and the shutter speed for an even number (EVEN) field respectively.

Namely, the CPU 105 reads a state set with the shutter-speed setting switch 109 and outputs an encoded shutter-speed set value of each field. The DSP 103 outputs a field pulse signal shown in FIG. 25. When the output signal is high, the shutter-speed set value on the EVEN field is input to an input terminal for shutter-speed setting of the DSP 103 through the multiplexer 107, while when it is low, the shutter-speed set value on the ODD field is input to the same terminal. Hence the imaging system as shown in FIG. 24 can set different shutter speeds depending on each field.

In general, when picking up an image with a CCD camera that has the same automatic shutter-speed in ODD fields and in EVEN fields, when a bright illuminant comes into a dark place as shown in FIG. 26, the vicinity of the illuminant disappears due to halation.

FIG. 26 shows an image ahead of a car taken with an on-board CCD camera, while radiating forward an infrared ray with an IR lamp as infrared radiating means during the run at night. The vicinity of a bright illuminant such as an oncoming headlight, and others disappears owing to the halation. This is because a general integral-metering CCD camera calculates exposure conditions under which darkness dominates around even if a strong light comes in when it is dark, for example, at night and others, so that the shutter speed can be slowed, which extends the exposure time for a brighter portion.

Although the shutter speed can be made faster so as to suppress the halation, a surrounding dark portion is darkened if doing so, thereby to cause the problem that the background is invisible, as shown in FIG. 27.

As shown in FIG. 28, reflections from road signs and others striking on the imaging area are controlled as is the case with the above, causing the problem that the scenery around the reflections is hardly visible.

While, the control for changing the shutter speed every field is so-called double exposure control, in which different shutter speeds are set every field. This outputs a bright image and a dark image alternatively; an invisible portion due to darkness can be displayed on a bright image (EVEN fields in this case) and an invisible portion due to halation can be displayed on a dark image (ODD fields in this case).

An image for each field is output alternately and can be displayed clearly on a monitor.

Although the double exposure control provides EVEN and ODD fields with proper exposure, a problem lies in that the control cannot always correspond to a situation in which incident light picked up by a CCD camera varies faster because it works with an ON/OFF control determined by some threshold.

The image is brightened suddenly in a situation where the double exposure control is operated when a strong light from an oncoming car suddenly has fallen on after viewer's car has turned a street corner and then the control is immediately stopped after the viewer's car has passed by the oncoming car, or the difference in the double exposure is reduced. That causes exposure to open both in an EVEN field and in an ODD field, making a viewer feel unnatural.

[Patent Publication] Japanese Examined Patent Application Publication No. 7-97841

Problems to be solved are an unnatural change in images just after a strong light falls on.

### SUMMARY OF THE INVENTION

The present invention is mainly characterized by outputting periodically and continuously images that are different in exposure depending on a signal storage time according to the extent to which how strongly an incident light falls on the imaging means, and extending a signal storage time gradually when no strong incident light falls on the imaging means in order that images can be obtained with unnaturalness suppressed.

The imaging system of the present invention is controlled so that it can output periodically and continuously the images that are different in exposure depending on a signal storage time according to the extent to which how strongly an incident light falls on the imaging means, and gradually extends a signal storage time when no strong incident light falls on the imaging means. Consequently it stops the double exposure control immediately after no strong signal has existed, or regulates the difference in the double exposure so that it does not become small rapidly, whereby to cause the brightness of the screen to change gradually and to provide less unnatural output images.

When the image processing unit controls the signal storage time so that it can be gradually extended with time intervals given, unnaturalness can be surely suppressed.

When the image processing unit counts the time interval with the number of frames, the time interval can be set easily, so that it can conduct control easily and surely.

When strong incident light falls on the imaging means and lasts for the predetermined number of frames and the image processing unit outputs continuously and periodically the images that are different in exposure depending on a signal storage time according to the extent of strength of the incident light, the double exposure control can be accurately conducted according to the extent of strength of incident light.

When the image processing unit samples high-luminance clusters with medium luminance extending therearound at one of the images output periodically, and controls the signal storage time of the other of the images output periodically according to the extent of the minimum luminance, an area gradually shifting to low luminance around the high-luminance clusters caused by strong light can be removed, or suppressed even if strong light such as the headlight of an oncoming car, and others falls on the imaging means. That is, even if an obstacle such as a pedestrian, and others exists in this area, it can be picked up as an image.

When the image processing unit ternarizes the one of the images to divide it into the attributes of high, medium, or low luminance, and controls the signal storage time of the other of the images according to the extent of the medium luminance around the high luminance, it can capture surely the extent of the medium luminance based on the number of the medium luminance around the high luminance, and can control surely the signal storage time of the other of the images output periodically.

When the image processing unit divides the one of the images into a plurality of blocks and divides the luminance mean values of each block by two thresholds to conduct the ternarizing process, it can process faster than a ternarizing process while keeping attention to each pixel.

When the image processing unit divides the one of the images into a plurality of blocks, divides each pixel for each block into the attributes of high, medium, or low luminance by two thresholds, and ternarizes the attribute that is larger in total number than any other attributes in each block as an attribute of the block, it is possible to conduct the ternarizing process while keeping attention to each pixel, leading to more accurate process.

When the image processing unit controls the signal storage time of the other of the images according to the maximum number in the number of attributes of the medium luminance around the attribute of the high luminance, it is possible to identify simply halation, enabling a rapid process.

When the image processing unit controls the signal storage time of the other of the images according to the number of attribute of the high luminance, the number of attributes of medium luminance detected around the attribute of high luminance, and the number of attributes of medium luminance ideally formed around high luminance, it is possible to identify accurately halation, enabling a accurate process.

When the image processing unit identifies the attribute of high luminance, searches sequentially therearound to identify the medium luminance around the high luminance, and combines sequentially the attributes of the high luminance when the attribute of an adjacent high luminance is identified, it is possible to sample high-luminance clusters accurately and rapidly.

When the infrared ray radiating means, the imaging means, and the image processing unit are provided with a car, the infrared ray radiating means radiates infrared ray outside the car, and the imaging means picks up an image outside the car, an area gradually shifting to low luminance around the high-luminance clusters caused by strong light can be removed, or suppressed even if halation caused by illumination of headlight of an oncoming car, and others. Consequently, even if an obstacle such as a pedestrian, and others exists in this area, it can be picked up as an image clearly.

### BRIEF DESCRIPTION OF THE DRAWINGS

FIG. 1 is a schematic view of a car to which a first embodiment of the invention is adopted.

FIG. 2 is a block diagram of imaging means and an image processing unit according to the first embodiment.

FIG. 3 is a flow chart according to the first embodiment.

FIG. 4 shows an output image obtained by taking a light source with a simple control.

FIG. 5 is a graph showing a change in density on a dotted line across the center of the strong light source, according to the first embodiment.

FIG. 6 shows an output image obtained by taking reflections with a simple control, according to the first embodiment.

FIG. 7 is a graph showing a change in density on a dotted line across the large reflection, according to the first embodiment.

FIG. 8 is a diagram in which the luminance data of an EVEN field are divided into several blocks, according to the first embodiment.

FIG. 9 is a table showing a division of blocks in colors based on the percentage of gray, according to the first embodiment.

FIG. 10 is a schematic diagram showing a division of blocks in colors, according to the first embodiment.

FIG. 11 is a schematic diagram showing the sequence of searching the inside of blocks, according to the first embodiment.

FIG. 12 is an output image of the original strong light source to be used for searching therearound, according to the first embodiment.

FIG. 13 is a processed image of the peripheral search shown in three colors, according to the first embodiment.

FIG. 14 shows a relationship between the standard number of blocks and the number of white blocks, where, (a) shows a schematic diagram of one white block, (b) that of two white blocks, and (c) that of three white blocks, according to the first embodiment.

FIG. 15 is a schematic diagram showing the number of blocks of halation detected, according to the first embodiment.

FIG. 16 is an output image showing a relationship between reflection and halation, according to the first embodiment.

FIG. 17 is a processed image of FIG. 16, according to the first embodiment.

FIG. 18 is a table showing differences in exposure of an ODD field with respect to an EVEN field, according to the first embodiment.

FIG. 19 shows a state in which strength of halation is shifting, according to the first embodiment.

FIG. 20 shows images changing according as halation becomes strong when an oncoming car suddenly appears; (a) output image at STEP0, (b) analyzed image of consecutive EVEN fields under the strength of halation greater than STEP0, (c) output image of STEP6, according to the first embodiment.

FIG. 21 shows images changing according as light becomes weak after the oncoming car has passed by; (a) output image of STEP6, (b) analyzed image of consecutive EVEN fields under the strength of halation less than STEP6, (c) output image of STEP5, (d) output image of STEP1, (e) analyzed image of consecutive EVEN fields under the strength of halation less than STEP1, and (f) output image of STEP0, according to the first embodiment.

FIG. 22 is an example of a processed image in which an obstacle can be seen around halation, according to the first embodiment.

FIG. 23 is an example of a processed image in which a scene is visible in disregard of the brightness of reflections, according to the first embodiment.

FIG. 24 is a block diagram of the imaging system, according to a conventional example.

FIG. 25 is output waveforms of a field pulse, according to a conventional example.

FIG. 26 shows an example of output image in which nothing can be seen in the vicinity of the light source by halation, according to a conventional example.

FIG. 27 shows an example of output image in which the surroundings cannot be seen owing to halation, according to a conventional example.

FIG. 28 show an example of output image in which the surroundings are hardly visible due to reflections, according to a conventional example.

FIG. 29 shows a state in which a screen suddenly became bright, according to a conventional example.

### DESCRIPTION OF THE PREFERRED EMBODIMENTS

The simple control has achieved the purpose of suppressing unnaturalness and enabling accurate image output.

[First Embodiment]

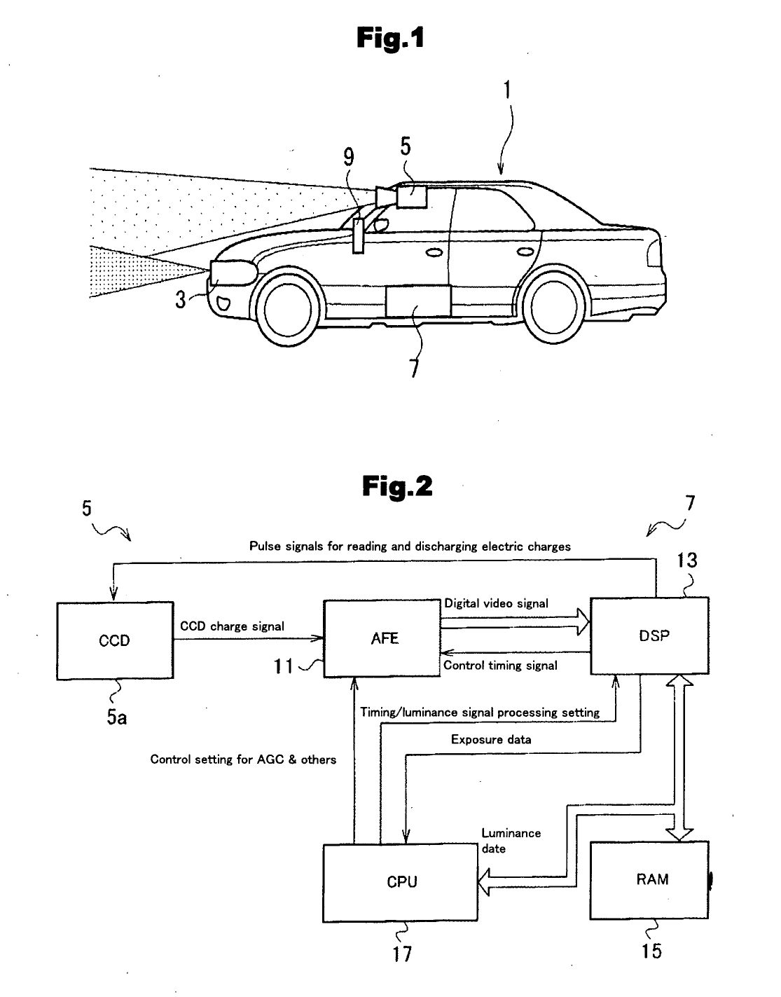

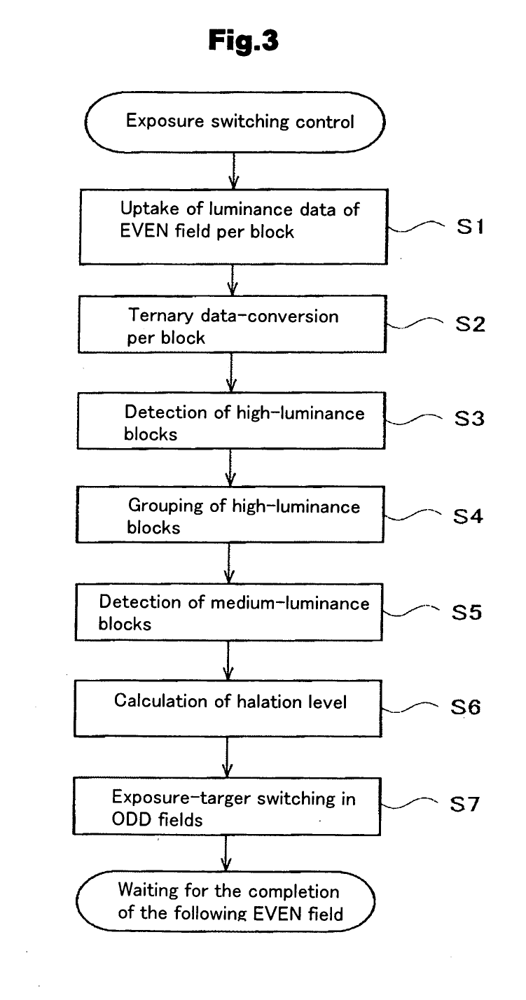

FIGS. 1 to 23 show a first embodiment of the present invention. FIG. 1 is a schematic view of a car to which the first embodiment of the present invention is adopted. FIG. 2 is a block diagram of the imaging system according to the first embodiment. FIG. 3 is a flow chart according to the first embodiment.

As shown in FIG. 1, an imaging system according to the first embodiment of the present invention applied to a car 1 comprising an IR lamp 3 as the infrared radiating means, a CCD camera 5 as the imaging means, an image processing unit 7 as the image processor, and further a headup display 9.

The IR lamp 3 radiates ahead of the car 1 in the running direction with an infrared ray, in order to enable the camera to take an image at a dark place, for example, at night. The CCD camera 5 takes an image ahead of the car 1 in the running direction, radiated by the infrared ray, and to convert it into an electric signal. The electric signal in this case is converted by a photo diode of a photosensitive unit in the CCD camera 5. The image processing unit 7 varies the signal storage time of the CCD camera 5 at a predetermined period and outputs the images with different exposure continuously and periodically.

The term signal storage time refers to one for each pixel. Varying the signal storage time at a predetermined period means that varying the number of the pulses discharging the unnecessary electric charges accumulated in each pixel resultantly varies the time accumulated, and it means the electronic shutter operation. Outputting continuously and periodically an image with a different exposure value means that the shutter speed is set for each field of the ODD and the EVEN according to the electronic shutter operation and that the images of the respective fields read out at the respective shutter speeds are continuously and alternately outputted, for example, in every 1/60 sec.

In the high speed shutter in which the shutter speed is made faster, a dark portion is difficult to pick up, but a bright portion can be seen sharply, to the contrary, in the low speed shutter in which the shutter speed is slowed, a bright portion is saturated, but a dark portion can be seen sharply.

The image processing unit 7 outputs continuously and periodically the images of which exposure differs depending on the signal storage time according to the extent to which how strongly an incident light falls on CCD camera 5. In this embodiment, high-luminance clusters with medium luminance extending therearound in the one of images outputted periodically are sampled, and the signal storage time of the other of images output periodically according to the extent of the minimum luminance is controlled.

As shown in FIG. 2, the CCD camera 5 and the image processing unit 7 comprises CCD 5a, AFE 11, DSP 13, RAM 15, and CPU 17 and others.

The CCD camera 5 includes parts of CCD 5a, AFE 11, DSP 13, and CPU 17. The image processing unit 7 includes a part of DSP 13, RAM 15, and CPU 17.

The AFE 11 is an analog front end processor to amplify the output signal of the CCD 5a and to convert analog signal to digital signal.

DSP 13 is a digital signal processing unit for signal conversion and video signal production process such as the production of timing signal for operating the CCD 5a, and the AFE 11, gamma correction of signals for CCD 5a via AFE 11, process of an enhancer, and digital signal processing.

The RAM 15 is a memory for storing temporarily the luminance data of images (=density) in EVEN fields outputted from the DSP 13.

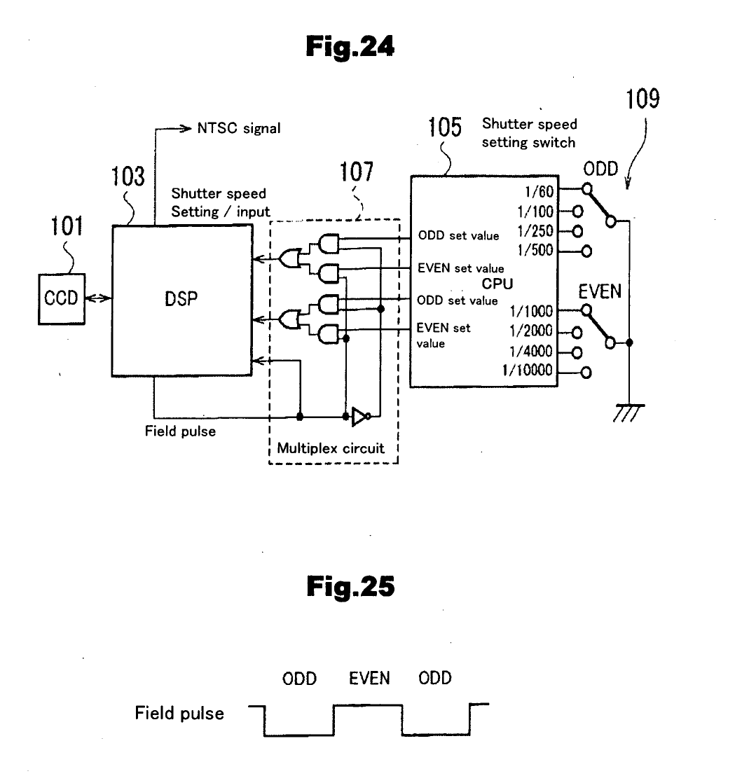

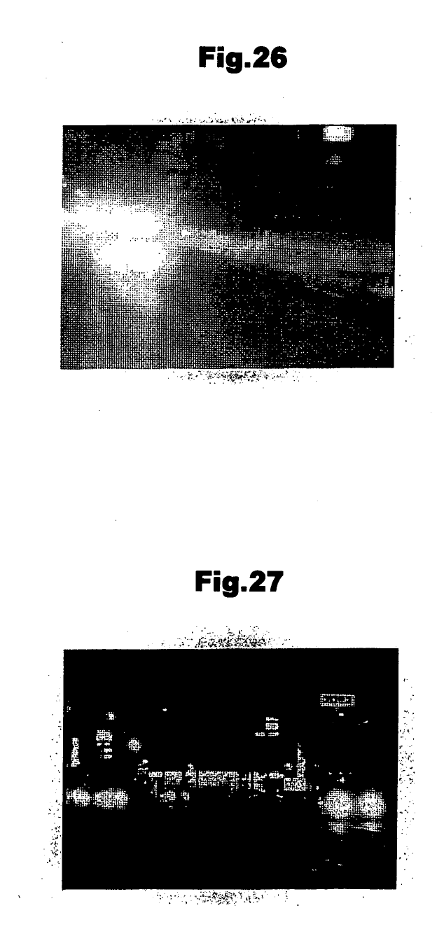

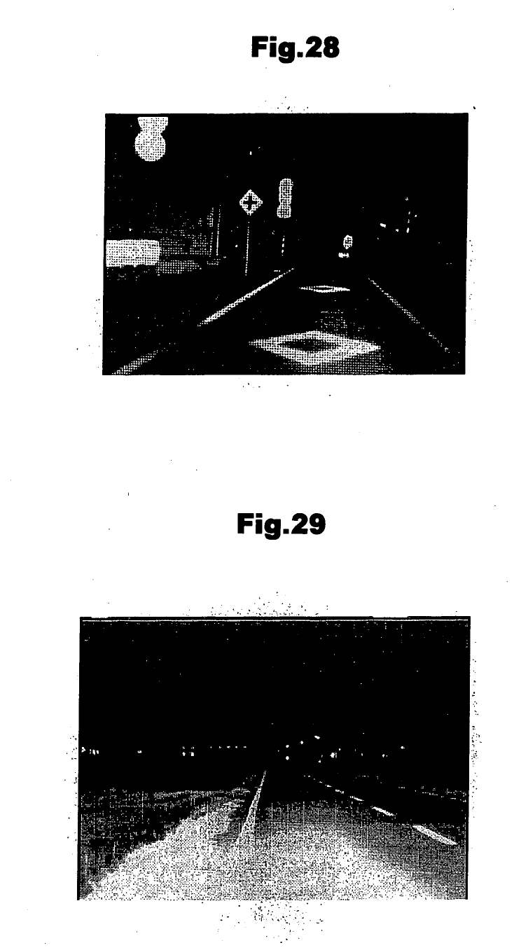

The CPU 17 performs various operations, and controls shutter speeds for each ODD field and EVEN field by the same configuration as depicted in FIG. 24. It calculates the optimum exposure condition from the total average density for the EVEN field to make an amplification and control for the AFE 11, and control the electronic shutter for CCD 5a via DSP 13.

Functions are described below.

The CPU 17 carries out initial set of shutter speed, and outputs shutter speed control signals for ODD fields and EVEN fields to DSP 13.

DSP 13 generates timing signals for operating CCD 5a and AFE 11. Output of the timing signals causes CCD 5a to pick up and signals are charged over all pixels of photo diodes of the photosensitive unit of CCD 5a. In the ODD field side, evey other odd-numbered pixels perpendicularly out of all pixels of photo diodes of the photosensitive unit are read at the preset shutter speed. In EVEN field side, signal charges of even-numbered pixels are read at the preset shutter speed.

Signal charges read with CCD 5a are amplified and converted to digital signals with AFE 11 and fed to DSP 13. DSP 13 carries out signal conversion and video signal production processes such as gamma conversion, enhancer process, and digital signal amplification process for the fed signals.

Luminance data of images in the EVEN fields output from the DSP 13 is stored temporarily in RAM 15.

The CPU 17 calculates the optimum exposure condition from the total average density for the EVEN field and conducts the control of the electronic shutter for CCD 5a via DSP 13.

The CPU 17 calculates exposure conditions by the exposure switching control for ODD fields in the flow chart shown in FIG. 3.

After the exposure switching control has been started, Step S1 conducts the process of “uptake of luminance data of EVEN field per block.” This process divides the luminance data of EVEN fields stored in RAM 15 into several blocks to calculate mean luminances for each block, and sends them to Step S2.

Step S2 conducts the process of “ternary data-conversion per block,” in which each block is converted into ternary data using two thresholds with respect to each mean luminance of the blocks divided by step S1, and thereafter the data are sent to Step S3.

Step S3 conducts the process of “detection of high-luminance blocks,” in which high-luminance clusters are detected from the ternary data of each block, and then the step proceeds to Step S4.

Step S4 conducts the process of “grouping of high-luminance blocks,” in which blocks of neighboring high-luminance portions are combined (grouped) so as to detect the magnitude of high luminance portions, i.e., the number of blocks, and then the step proceeds to Step S5.

Step S5 conducts the process of “detection of medium-luminance blocks,” in which groups with the spread, i.e., the number of blocks, of medium-luminances, around the combined high-luminance portions are sampled, and then the step proceeds to Step S6.

Step S6 conducts the process of “calculation of halation level,” in which the magnitude, i.e., strength, of halation is calculated from the magnitude of the high luminance and the degree of the spread of medium luminances, or only from the degree of the spread of medium luminances. This calculation detects the maximum strength of halation in an EVEN field, and the step proceeds to Step S7.

Step S7 conducts the process of “exposure-target switching in ODD fields,” in which it is calculated how deep the exposure of ODD fields will be with respect to EVEN fields according to the strength of halation, and the process completes here. With this completion, it advances to the process for the following EVEN field.

Using the calculated exposure conditions obtained by the above manner the electronic shutter of CCD 5a, the AGC gain of AFE 11, and the digital gain of DSP 13 are controlled to optimize the brightness of images to be obtained.

It is also effective to use the attributes of pixels accounting for the majority in blocks instead of the mean luminance for each block for calculating the ternary data in the Step S2.

By the processes described above, strong light can be made less influential without reducing the brightness of images at dark portions caused by strong light such as light of the headlight of an oncoming car falling on CCD camera 5 shown in FIG. 1 at night.

In general, a CCD camera of an imaging system used in cars has an interlace scanning system as a video system. The video signal consists of two fields; EVEN field and ODD field as stated above. Outputting each of two fields alternately allows a viewer to see an image with a certain resolution.

A typical CCD camera calculates exposure conditions on the basis of the average luminance of light received either in EVEN field or in ODD field. The exposure conditions are electronic shutter speed for controlling discharge of charges of CCD via DSP, the amplification factor of AFE, i.e., AGC gain, and the digital amplification of DSP. Control of those conditions can produce optimal bright images to be output to a TV monitor.

A common CCD camera applies the exposure conditions obtained above to both EVEN and ODD fields, as a result, both fields will be output as images with almost same brightness as each other's field. A camera using such control method tends to output an image saturated in white in its portions of strong light and surroundings therearound, known as halation. This is because exposure conditions are determined by mean value of total luminance based on the strong light, for example, headlight of an oncoming car, striking on the camera especially at night.

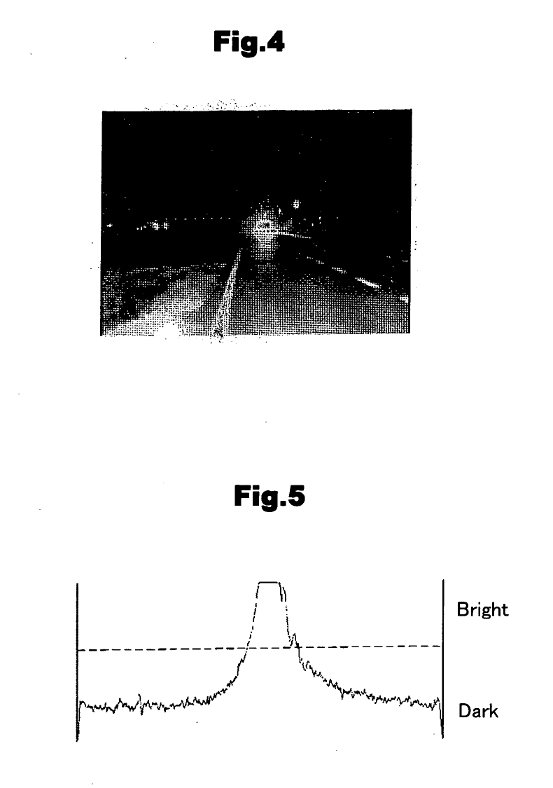

The halation refers to spreading of light beyond its boundary on a strong light and whitely saturated surroundings therearound as shown in FIG. 4. FIG. 5 shows the luminance of pixels on a specific line shown in dotted line across the center of the strong light in FIG. 4. That is, the strong light and its surrounding tend to be saturated at the maximum luminance and get dark gradually outward.

In this situation, for example, when a pedestrian exists in the saturated part and its surrounding of the image, the camera cannot pick it up as an image to be output. It is tolerable for the strong light, i.e., headlight itself, to be saturated in white at its center. Ideally, however, it is preferable that the periphery including its vicinity, for example, a space between left and right headlights can be picked up when a pedestrian exists there and output without any saturation.

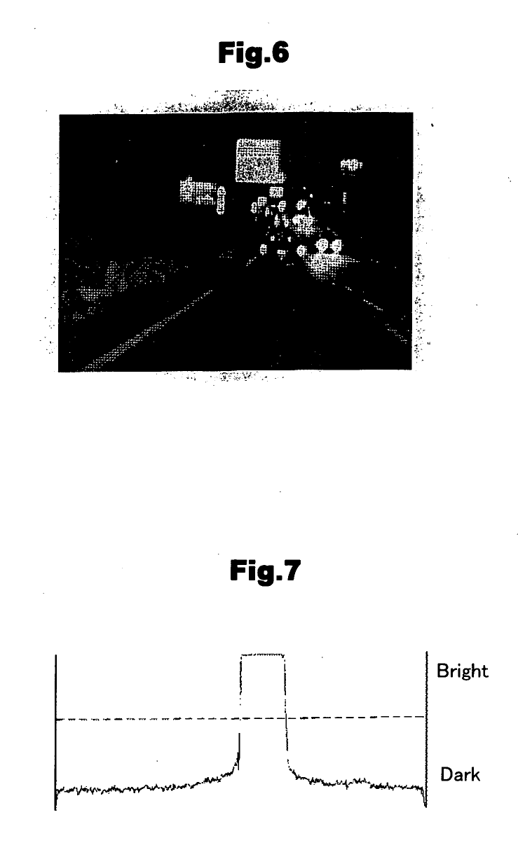

On the other hand, FIG. 7 shows the luminance of pixels on a specific dotted line drawn across the center of the reflected light by the signboard from a headlight as shown in FIG. 6. Although the reflection itself is whitely saturated, halation hardly spread over its surroundings. The luminance data gives a sharp contour. Even when there is an obstacle such as a pedestrian exists in that place, it can be completely picked up as an image. In this case, there is no need to suppress the exposure of ODD fields with respect to EVEN fields unlike the measures of halation described above. It is preferable for ODD fields to get a sufficient exposure as with EVEN fields in consideration that the amount of light of a photographic subject is small at night, thereby making easier recognition of a target obstacle.

The purpose of the present invention is, for EVEN fields, to detect halation shown in the flow chart of FIG. 3, calculate exposure conditions based on the new findings described above in order to output dark environment as brighter images in use especially at night. For ODD fields, it aims to provide the difference in exposure on a basis of the luminance data obtained from EVEN fields to produce images less susceptible to influences from strong light as stated below.

The synthesis of images for each field with the above two different characteristics enables the output of images that are kept bright around the strong light without any halation even if the strong light is received at night.

Hereinafter, a series of processes is described below including: the detection of the strength of halation based on luminance data in EVEN fields; calculation of exposure conditions according to the strength; and the output of the calculated result.

(Block-Dividing)

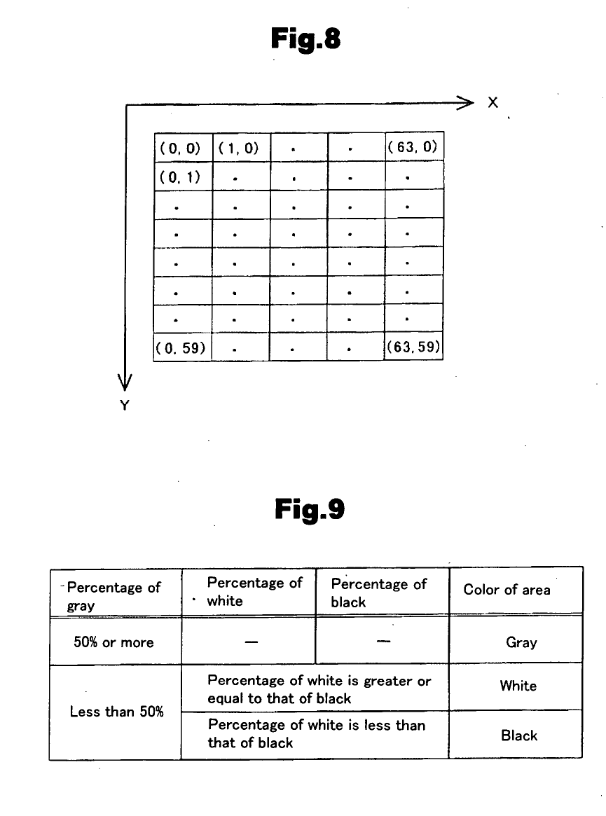

The block-dividing is implemented in Step S1 shown in FIG. 3. Luminance data of an EVEN field fed from DSP 13 to RAM 15, e.g., consisting of 512 dots×240 lines, are divided into several blocks as shown in FIG. 8. The data are divided into 64×60 blocks with one block to be 8 dots×4 lines, for example.

(Calculation of Mean Value of Luminance Data)

The calculation of mean value of luminance data for each block is implemented in Step S1 shown in FIG. 3. Luminance mean values of all pixels, for example, 8×4 pixels, forming each block are calculated.

(Ternarizing the Mean Values of Luminance)

Ternarizing the mean values of luminance is implemented in Step S2 shown in FIG. 3 to divide mean values of luminance of each block into a ternary by two thresholds. For example, when each luminance is taken to be 8 bits, the minimum luminance becomes 0, and the maximum luminance 255. Then, each block can be divided into any attributes of white, gray, or black with a white threshold and a black threshold to be 220 (or more) and 150 (or more) respectively and with the medium between the two to be gray.

For instance, attributes are divided as follows.

When an object pixel density is greater than or equal to white threshold, the attribute is white.

When a white threshold is greater than an object pixel density, but an object pixel density is greater than or equal to black, the attribute is gray.

When an object pixel density is less than black threshold, the attribute is black.

Instead of ternarizing mean values of luminance of each block by two thresholds as described above, mean values of luminance are ternarized for each pixel by the same thresholds. The one that is larger in total number than any other attributes of high, medium, and low luminances in each block also may be taken as an attribute of that block.

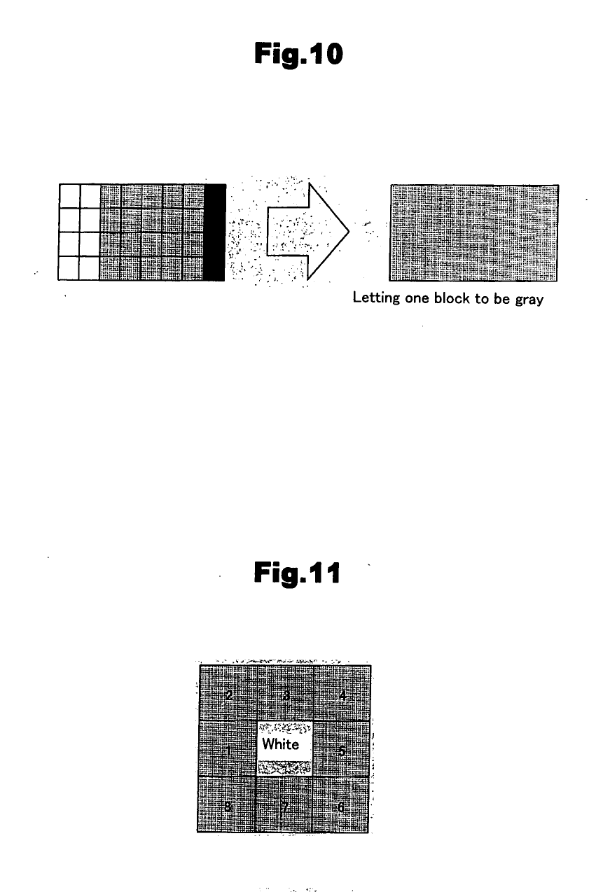

For example, a block is categorized into any of three colors; white, gray, and black according to a percentage in which gray is included in one block ternarized with three colors for each pixel. As shown in FIG. 9, when the percentage of gray is 50% or more, a block color is set to gay. When the percentage of gray is less than 50%, a block color is set to white or black. In FIG. 10, the gray accounts for 50% or more in one block, so that the attribute of one block has been set to gray.

Alternatively, it is possible to detect halation and calculate exposure as described below while keeping attention on each pixel without block-dividing.

(Grouping Process)

Grouping process is implemented in Steps 2, 3, and 4 shown in FIG. 3, in which a white cluster that is a group of blocks having a white attribute is detected with the following steps based upon the ternarized attributes of blocks.

In FIG. 8, white blocks are found from the block (0, 0) toward right direction, that is, the plus direction of the x-coordinate. If no white block is found out at the final block (63, 0) on the first line, the next search is started at the second line (0, 1). Thus, white blocks are found sequentially.

When white blocks are found out, next white blocks are found in its peripheral eight blocks clockwise starting from the block at the left-hand side. Thus, connecting adjacent white blocks sequentially can form a periphery of cluster of blocks having a white attribute. (Peripheral search)

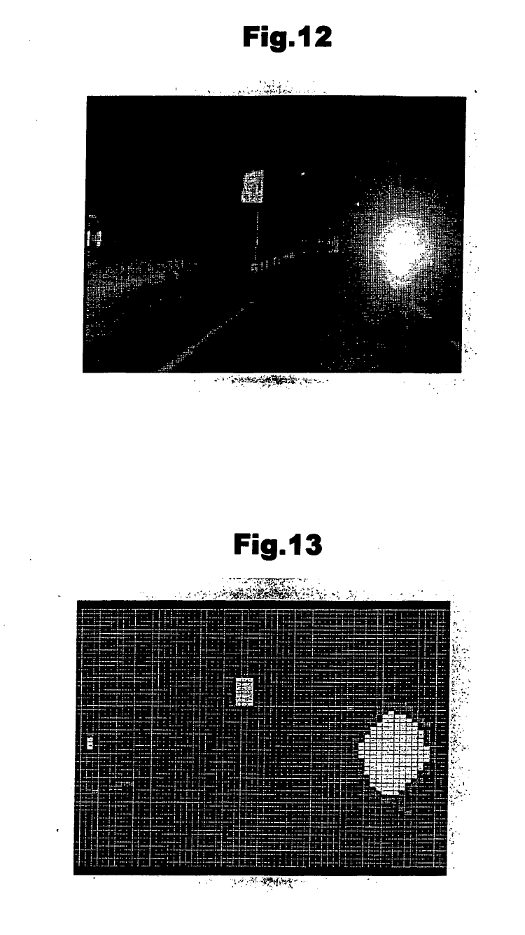

As an example, an output image is shown in FIG. 12 used as a source for searching a periphery of a strong light source. FIG. 13 is processed images showing the peripheral search displayed in three colors. The strong light in FIG. 12 is a headlight. The periphery is formed by a series of gay blocks shown in FIG. 13. Letting all the inside surrounded with such gay blocks be white attribute ones leads to the formation of one group.

(Halation Detection)

Halation detection is implemented in Step S5 in FIG. 3. As earlier mentioned, the halation refers to a state in which a central part saturated by strong light gradually gets dark therearound. In terms of ternarized attributes of blocks, the halation is a state in which blocks with a gray attribute surround the groups of white blocks.

Then, gay blocks adjacent the periphery of white block groups are found out, and the number is counted.

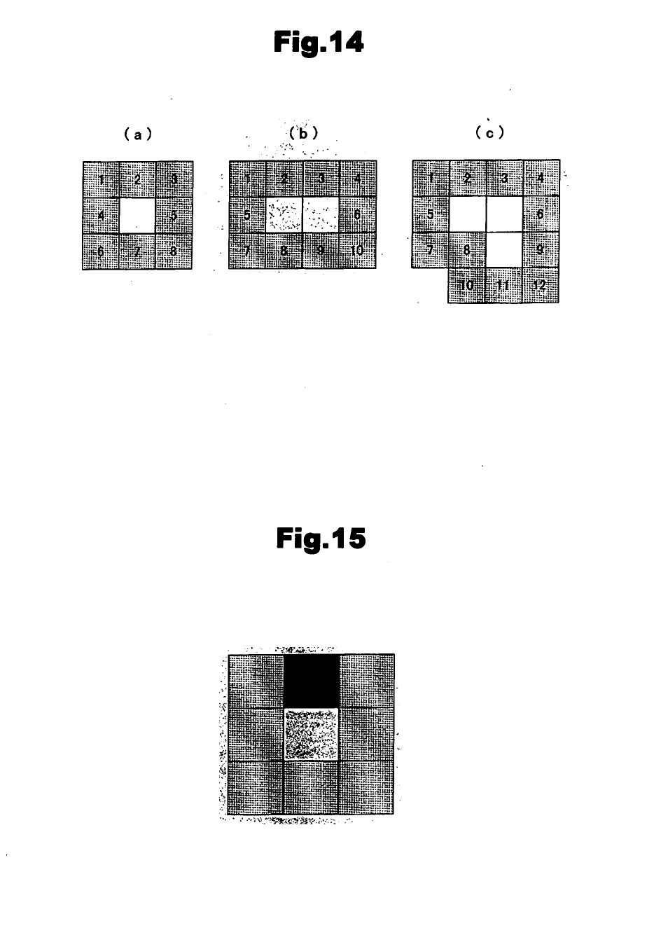

In ideal (reasonable) halation, gay blocks will exist at the vicinity of one white-block group as shown in FIG. 14. For instance, when a white block group is formed with one white block, the number of gray blocks is eight. When a white-block group is formed with two white blocks, the number of gray blocks is 10. When a white-block group is formed with three white blocks, the number of gray blocks is 12. The number of such gray blocks is the standard number of blocks calculated by the number of white blocks in the calculation method 2 described later.

(Strength of Halation)

The strength of halation is calculated at Step S6 in FIG. 3. The strength of halation in a screen is calculated from white-block group detected at the above step and gray blocks around them.

There will be following two methods for obtaining the strength of halation based upon:
1) the maximum value of the number of gray blocks adjacent to a white-block group; and
2) the size of white blocks and certainty of halation of the block.

Method 1: A method in which the maximum value of the number of gray blocks adjacent to a white-block group is obtained for each white-block group.

Halation detection is conducted by calculating the number of halation (gray) appearing around a light source (white). The place where gay blocks detected around white-block group are greatest in number is set to the strength of halation.

The strength of halation=the number of grays adjacent to white (however, the number being greatest on one screen) As shown in FIG. 15, when a white is detected in one block, all blocks adjacent thereto are checked and the strength of halation of one block is set to “7.”

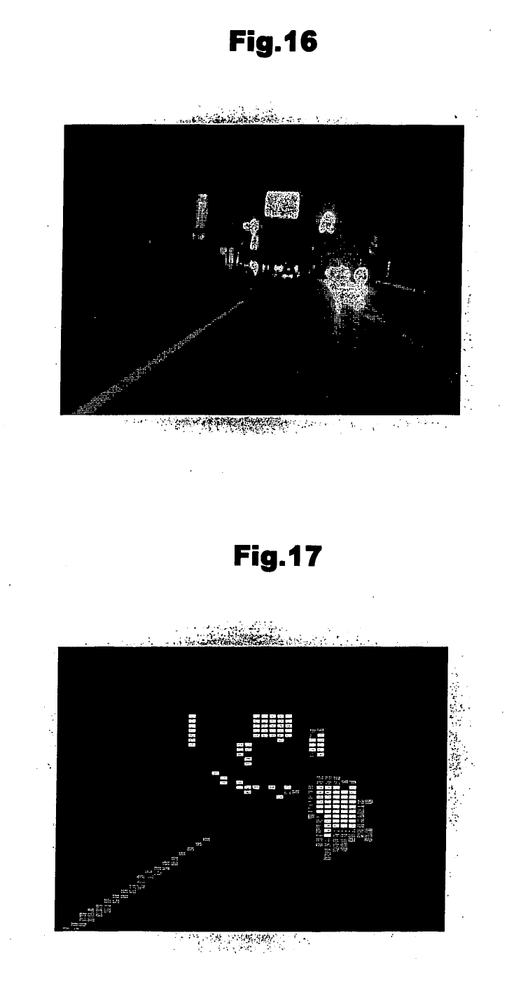

FIG. 16 shows an unprocessed image of reflections and halation. FIG. 17 shows an image obtained by processing the original image to divide it into three colors. When there are many white blocks, or their groups in an image as shown in FIG. 17, the surroundings of all white blocks and white-block groups are searched. Then, as discussed above, the strength of halation is set at the place where gray blocks are greatest in number.

(Results of Search)

The results obtained by calculating the example of image processing in FIG. 17 with the method 1 are given below.

The number of gray blocks around the large billboard (at upper almost middle); 0

The number of gray blocks around the small billboard at left hand side (at upper almost left); 0

The number of gray blocks around the taillight of the forward car in the middle (at the left neighboring the large cluster at the bottom); 2

The number of gray blocks around the right streetlamps (at the upper right); 4

The number of gray blocks around the headlight of the forward oncoming car (at bottom right); 32

As is clear from FIG. 17, the gray blocks at the bottom right surrounding the greatest white-block group are the greatest in number. This number of gray blocks shall be referred to as the strength of halation representing the magnitude of halation.

As an example, the strength of halation mentioned above is 32, because the number of gray blocks around the headlight of the forward oncoming car amounts to 32.

Method 2: A method in which the strength of halation is obtained from the size of white blocks and certainty of halation strength.

Probability in which a block is judged to be halation is calculated from the relationship of the number of gray blocks actually counted around the white-block group and the standard number of blocks (the number of gray blocks shown in FIG. 14) calculated from the number of white blocks forming the white-block group. Probability in which a white-block group is judged to be halation is calculated by the following equation.

Halation probability (%)=(dividing the number of gray blocks around white-block group by the standard number of blocks) multiplied by 100

A numerical value obtained by multiplying the halation probability by the size of white-block group (the number of white blocks forming the group) shall be reffered to as the strength of halation representing the size of halation.

The strength of halation is calculated below using an example of the processed image in FIG. 17.

The strength of halation around the large billboard (at upper almost middle); 0/26×100×21=0

The strength of halation around the small billboard at left hand side (at upper almost left); 0/26×100×7=0

The strength of halation around the taillight of the forward car in the middle (at the left neighboring the large cluster at the bottom); 2/8×100×1=25

The strength of halation around the right street lights (at the upper right); 4/18×100×8=178

The strength of halation around the headlight of the forward oncoming car (at bottom right); 32/37×100×43=3718

The greatest value out of the strength of halation in each white-block group thus calculated is set to the strength of halation in this scene.

That is, the strength of halation of the above example is 3718 because the halation around the headlight of the forward oncoming car is the greatest.

(Calculation of Exposure Conditions)

Exposure conditions are calculated at Sep S7 in FIG. 3.

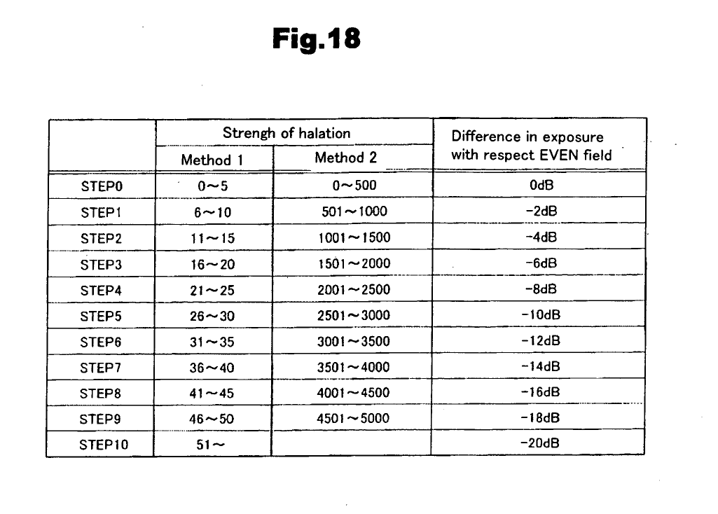

Thus, the strength of halation of the EVEN field is obtained. Then, the difference in exposure of an ODD field with respect to an EVEN field is obtained according to the strength of halation, for example, in accordance with FIG. 18 to determine exposure conditions for the ODD field, whereby to suppress halation.

That is, when the strength of halation obtained by the above method 1 is, for example, in the range from 0 to 5 on STEP0, the difference in exposure is set to 0 dB. When it is in the range from 31 to 35 on STEP6, the difference in exposure is set to −12 dB. In the method 2, when the strength of halation obtained is, for example, in the range from 0 to 500 on STEP0, the difference in exposure is set to 0 dB. When it is in the range from 3001 to 3500 on STEP6, the difference in exposure is set to −12 dB.

There is no difference in exposure between the ODD field and the EVEN field in the range of STEP0 by this setting. In the range of STEP6 the exposure of the ODD field is set to a value of 12 dB as small as that of the EVEN field.

As with the above, when the strength of halation is within the range of any of STEP0 to STEP10, the exposure of an ODD field is set at a lower exposure compared with that of an EVEN field as shown in the corresponding values in the right column.

The above exposure setting enables the double exposure control according to the strength of halation. That provides images that are brighter on a dark part and are darker on a strong-light part without causing large halation even if a strong light such as the headlight of a car is incident under a dark environment such as at night.

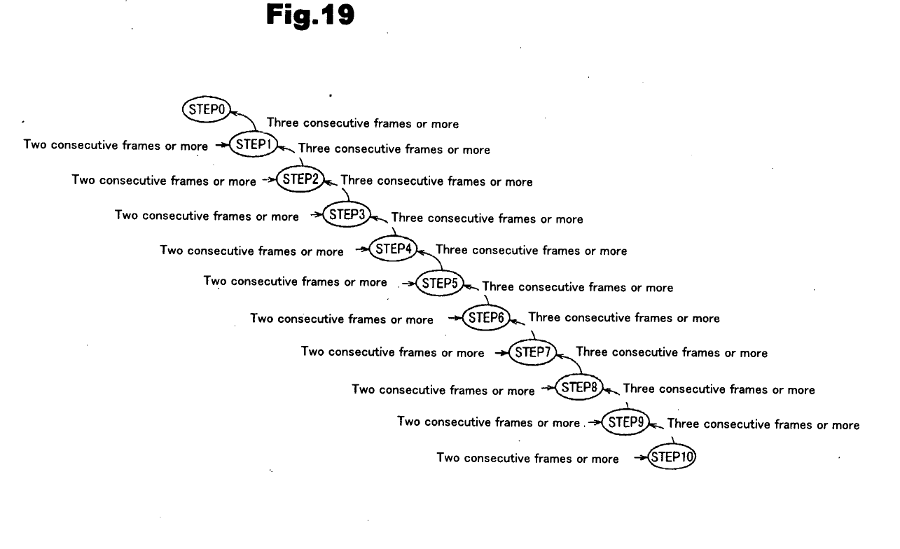

In practice a double exposure control is conducted in response to strong light as shown in FIG. 19 to mitigate unnaturalness caused by switching brightness of a screen. While, according as light becomes weak, images are gradually brightened by extending gradually the signal storage time of ODD fields with the control.

That is, the double exposure control promptly operates according to the strength of halation when the strong light of headlight of an oncoming car is suddenly incident after viewer's car has turned a corner. In this case, returning the strength of halation to STEP0 immediately after the oncoming car has gone by changes the exposure of images suddenly, resulting in unnaturalness.

Then, as described above, the images of ODD fields are gradually brightened to remove or suppress unnaturalness when incident light to CCD camera 5 becomes weak after each other's has gone by.

More specifically, at the situation where an oncoming car lies when a viewer's car has tuned a street corner, the strength of halation is, for example, in the range of STEP6. In this embodiment shown in FIG. 19, the exposure of ODD fields is immediately reduced by the control of STEP6 that is designed to operate when the predetermined number of frames is kept in series at the EVEN fields, or lasting for two consecutive frames. When the light becomes weak after the oncoming car passed by, the signal storage times of the ODD fields are gradually elongated with time intervals given. In this embodiment, when the strength of halation less than STEP6 lasts for three consecutive frames or more, the control proceeds to STEP5. Subsequently, when the strength of halation less than STEP5 lasts for three consecutive frames or more, the control proceeds to STEP4. Thus, gradual change of the control causes images of ODD fields to brighten gradually. Thus, the gradual change of exposure of images allows unnaturalness to be removed or suppressed. The purpose of shifting STEPs at three consecutive frames or more is to obtain more natural images by setting simply and accurately the time interval for a change in images and by suppressing a sudden change in output images.

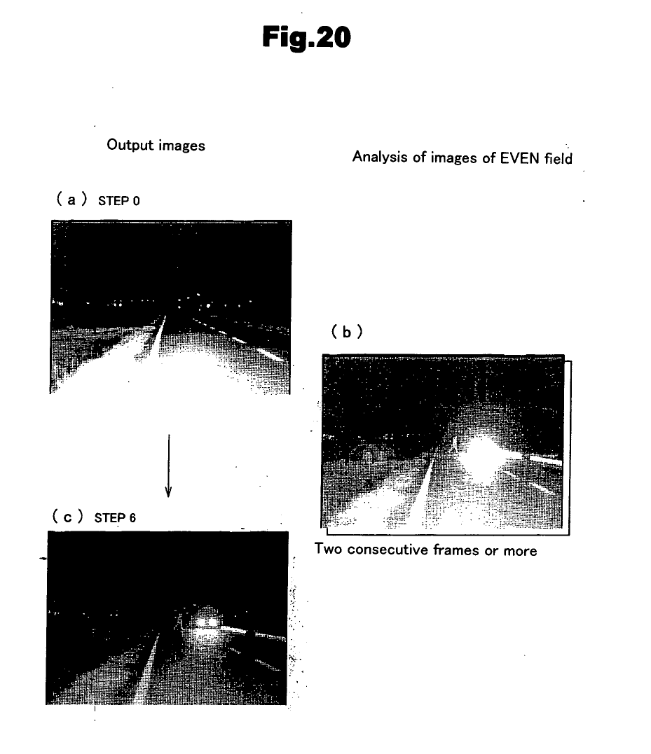

FIG. 20 shows a change in images under a sudden strong halation caused by the existence of an oncoming car; (a) shows output image at STEP0, (b) an analyzed image of consecutive EVEN fields under stronger halation than STEP0, and (c) an output image of STEP6.

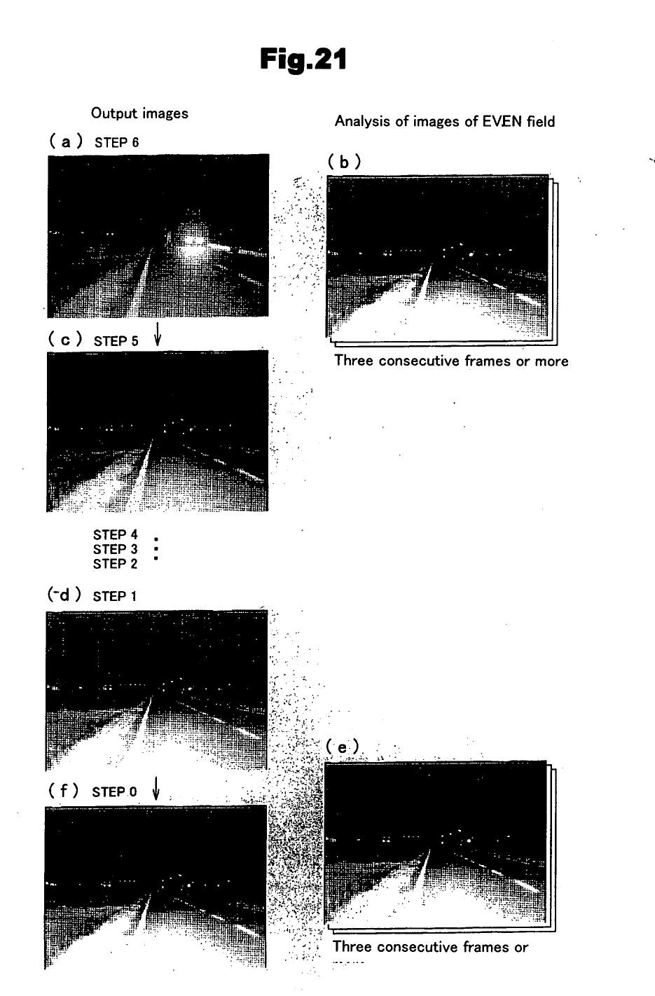

FIG. 21 shows a change in images of which light is becoming weak after the oncoming car has passed by; (a) shows an output image of STEP6, (b) an analyzed image of consecutive EVEN fields under weaker halation than STEP6, (c) an output image of STEP5, (d) an output image of STEP1, (e) an analyzed image of consecutive EVEN fields under weaker halation than STEP1 and (f) an output image of STEP0.

In FIG. 20, the strength of halation steps up from STEP0 (a) to, for example, STEP6 because of the existence of an oncoming car, and this state (b) lasts for two consecutive frames, and then the control of STEP6 immediately reduces the exposure of ODD fields as shown in (c).

FIG. 21 shows a change in STEPs; (a an image at the strength of halation of STEP6 with an oncoming car existing, (b) an image at the strength of halation less than STEP6 lasting for three consecutive frames or more while light becomes weak after the oncoming car has passed by, and (c) an image at the strength of halation of STEP5. Subsequently, when the strength of halation less than STEP5 lasts for three consecutive frames or more, the control proceeds to STEP4 shown in (c). As with the above, the control steps down to STEP3, STEP2, and STEP1. Finally, as shown in (e), when the strength of halation less than STEP1 lasts for three consecutive frames or more, the control proceeds to STEP0 shown in (f). In this way, gradual change of control from, for example, STEP6 to STEP0 gradually brightens images of the ODD fields.

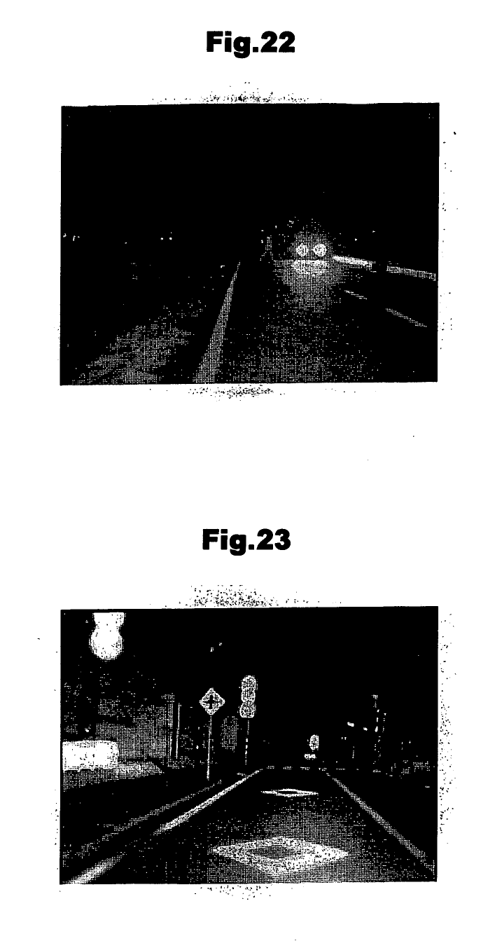

As described above, exposure control can be changed for each direct light and reflective light. Even when strong light such as headlight and others, is incident directly, halation that is gradually getting dark around the region of white saturation at the center can be removed or suppressed while suppressing unnaturalness shown in FIG. 22. Consequently, even if there is an obstacle such as a pedestrian and others in this part, it can be picked up as an image.

For reflective light from a headlight of a car reflecting the billboard, as shown in FIG. 23, the reflective light itself becomes a whitely saturated image, but it hardly spreads around the image. The luminance data gives a sharp contour. Even when an obstacle such as a pedestrian and others exists there, it can be completely picked up as an image. In this case, there is no need to suppress the exposure of ODD fields with respect to EVEN fields unlike the measures of halation described above. It is preferable for ODD fields to get a sufficient exposure as with EVEN fields in consideration that the amount of light of a photographic subject is small at night, thereby making easier recognition of an obstacle.

As described above, according to the embodiment of the present invention, even when a strong light such as headlight of an oncoming car is directly incident, halation therefrom can be reduced, thereby an obstacle, pedestrian, and others around it can be imaged. Even when a light reflected by road signs and road markings strikes, it is possible to get sufficient exposure and and bright image.

Even when strong light falls on the CCD camera 5, images with different exposures depending upon signal storage time according to the extent of the strength can be continuously and periodically output. When no strong incident light exists, control is conducted so that the signal storage time is gradually elongated, thereby the double exposure control is stopped immediately after no strong signal has been incident, or regulates the difference in the double exposure so that it does not become small rapidly. As a result, it is possible for the brightness of a screen to be changed gradually, thereby to control images with unnaturalness suppressed.

When the image processing unit 7 conducts control so that the signal storage time can be gradually elongated with time intervals given, unnaturalness can be surely suppressed.

When the image processing unit 7 counts the time interval by the number of frames, the interval can be easily determined, and a sure and easy control is possible.

Outputting continuously and periodically images that are different in exposure depending upon a signal storage time according to extent of strong light falling on the CCD camera 5, and lasting for the predetermined number of frames, the image processing unit 7 can conducts precisely the double exposure control according to the extent of the strong light.

The image processing unit 7 conducts ternary process of the images of EVEN fields to divide them to the attributes; white as high luminance, gray as medium luminance, or black as low luminance, and can control the exposure of the ODD fields according to the number of gray blocks around the white-block group.

In consequence, it captures the extent of gay blocks based on the number of gray blocks around white-block groups to surely control the exposure of the ODD fields of images periodically output.

The image processing unit 7 divides the EVEN fields of the images into a plurality of blocks and divides luminance mean values of each block by two thresholds to ternarize them.

Consequently, it can conduct faster processing compared to ternary process with our attention kept to each pixel.

The image processing unit 7 divides the EVEN fields of the images into a plurality of blocks, divides each pixel for each block into attributes of white as high luminance, gray as medium luminance, or black as low luminance by two thresholds, and conducts ternary process of the attribute that is larger in total number than any other attributes in each block as an attribute of the block.

In consequence, more accurate process is possible because the ternary process can be conducted while keeping attention to each pixel.

The image processing unit 7 can controls the signal storage time of images of the ODD fields according to the maximum number in the number of gray blocks around the white-block group.

Consequently, it can identify halation with ease to conduct a rapid process.

The image processing unit 7 can control the signal storage time of images of the ODD fields according to the number of the white-block groups, the number of gray blocks detected around the white-block groups, and the number of gray blocks ideally formed around the white-block groups.

In consequence, it can identify accurately halation to conduct more accurate process.

The image processing unit 7 can identify the white blocks to search its surrounding sequentially, and then identifies gray blocks around white blocks. When adjacent white blocks are identified, it can combine the white blocks sequentially.

In consequence, it can sample white block clusters accurately and rapidly to control.

In the imaging system according to the present invention, the IR lamp 3, CCD camera 5, and image processing unit 7 are provided with a car. The IR lamp 3 radiates infrared rays in front of the car. The CCD camera 5 can pick up images in front of the car.

In consequence, even when halation is caused by lighting and others such as the headlight of an oncoming car, a region shifting gradually to low luminance around a high-luminance cluster can be removed or suppressed, and even when there exists any obstacle such as a pedestrian and others at the area, the system can pick it up clearly as an image.

In addition, a relation between an EVEN field and an ODD field may be set in reverse. That is, the strength of halation of the ODD field is obtained first, and then difference in exposure of the EVEN field with respect to the ODD field is obtained according to the strength of halation to suppress the exposure of the EVEN field.

The present invention may be applied to a simple double exposure control and others so that a signal storage time is gradually elongated according as light gets weak after an oncoming car has passed by.

A cluster of several pixels as well as a single pixel may be read in the ODD field and EVEN field depending upon DSP 13 for processing charges for each pixel.

In the embodiment, although the output image is displayed with the headup display 9, but it may be displayed on a display installed on a vehicle compartment and others. Further, the IR lamp radiates forward in the running direction of a car, but it may be constructed so that the lamp radiates backward, or laterally so as to pick up the rear and sides with CCD camera 5.

The imaging system may be applied not only a car but a motorcycle, a marine vessel, and the other vehicles, or it may be constructed as an imaging system separated from the vehicle.

1. An imaging system comprising:
infrared ray radiating means for radiating an infrared ray;
imaging means for picking up an image of a place radiated by the infrared ray radiating means and converting the image into an electric signal; and
an image processing unit capable of outputting an image with a different exposure value continuously and periodically, while varying a signal storage time in the imaging means at a predetermined period, wherein the image processing unit outputs an image with a different exposure value depending upon the signal storage time according to the extent to which how strongly an incident light falls on the imaging means and elongates the signal storage time gradually when there has been no strong light falling on CCD camera.

2. The imaging system according to claim 1, wherein the image processing unit conducts control so that the signal storage time can be gradually elongated with time intervals given.

3. The imaging system according to claim 2, wherein the image processing unit counts the time interval by the number of frames.

4. The imaging system according to one of claims 1 to 3, wherein the image processing unit outputs an image with a different exposure value depending upon a signal storage time according to the extent to which a strong incident light falling on the imaging means lasts for a predetermined number of frames.

5. The imaging system according to one of claims 1 to 3, wherein the image processing unit samples high-luminance clusters having a medium- luminance extending therearound in one of the images output periodically, controls the signal storage time of the other of the images output periodically according to the extent of the minimum luminance, and conducts control so that the signal storage time of the other of the images can be elongated gradually when there has been no strong light falling on the image means.

6. The imaging system according to claim 5, wherein the image processing unit ternarizes the one of the images to divide it into the attributes of high, medium, or low luminance, and controls the signal storage time of the other of the images according to the extent of the medium luminance around the high luminance.

7. The imaging system according to claim 6, wherein the image processing unit conducts the ternarizing process by dividing the one of the images into a plurality of blocks, and dividing the luminance mean values of each block by two thresholds.

8. The imaging system according to claim 6, wherein the image processing unit divides the one of the images into a plurality of blocks, divides each pixel for each block into the attributes of high, medium, or low luminance by two thresholds, and ternarizes an attribute that is larger in total number than any other attributes of each block as the attribute of the block.

9. The imaging system according to claim 6, wherein the image processing unit controls the signal storage time of the other of the images according to the maximum value of the number of attributes of medium luminance around the attribute of high luminance.

10. The imaging system according to claim 6, wherein the image processing unit controls the signal storage time of the other of the images according to the number of attribute of high luminance, the number of attribute of medium luminance around the attribute of high luminance, and the number of attribute of medium luminance ideally formed around high luminance.

11. The imaging system according to claim 9, wherein the image processing unit identifies the attribute of the high luminance, searches sequentially therearound to identify the medium luminance around the high luminance, and combines sequentially the attributes of the high luminance when the attribute of an adjacent high luminance is identified.

12. The imaging system according to any one of claims 1 to 3, wherein the infrared ray radiating means, the imaging means, and the image processing unit are provided with a car, the infrared ray radiating means radiates infrared ray outside the car, and the imaging means picks up an image outside the car.
